(19) United States
(12) Patent Application Publication
(10) Pub. No.: US 2003/0066442 A1
(43) Pub. Date: Apr. 10, 2003

(54) Screen printing frame connectors

(76) Inventor: Ronald Salisbury, San Diego, CA (US)

Correspondence Address: Steven W. Webb, Law Offices of Steven W. Webb, 655 Second Street, Encinitas, CA, 92024, US

(21) Appl. No.: 09/972,636

(22) Filed: Oct. 9, 2001

(51) Int. Cl. B41F 1/00; B05C 17/06

(52) U.S. Cl. 101/127.1

(57) ABSTRACT

An improved screen printing frame connector is presented, the connector possessing flanges for easy insertion of frame side members and also providing large drainage holes to permit easy drying of the frame after washing.

### BACKGROUND OF THE INVENTION

This invention relates to rectangular screen printing frames and in particular to an improvement in screen printing frame corner connectors.

Existing rectangular screen printing frames are intended to support the screen mesh while maintaining an even strain on on the screen at all points when the screen is having ink forced through it. Uneven screen tension causes uneven printing of the desired image. Hence, a rigid and strong frame is required to obtain the best results, requiring strong and lightweight components.

Typical screens are made out of extruded aluminum hollow tubing side members with rectangular cross-sections. The side members are connected at the corners by welding the ends of the side members together or by fastening them to connectors. Welding the frames together is expensive and requires relatively thicker metal in the side members, thereby increasing the weight of the screen. A lower cost approach is to make the corner connectors such that the side members slide into them fixedly and are then glued or fastened.

A recurring problem with screen printing frames is that they need to be washed with water regularly between uses. While aluminum does not absorb water, a pinhole in a weld will allow water into the hollow frame interior. Washed screens are then air dried. Regardless of how well the screens are dried, there is usually residual water left in the frame members or connectors, and the water will drip onto the substrate, mixing with the printing ink. Existing inventions do not address this problem.

The prior art discloses brackets as in U.S. Pat. No. 2,545,277, tensioners as in U.S. Pat. Nos. 3,908,293 and 6,038,969, screw adjusters as in U.S. Pat. Nos. 5,076,162, 5,802,971 and 5,255,600, and internal connectors with mitred ends U.S. Pat. No. 4,452,138.

None of these devices have drain holes nor do the provide a four-sided connection between the side members. U.S. Pat. No. 4,452,138 teaches a mitred, 45-degree angle two-side connection that has less strength than the present invention.

This invention differs from the above-listed devices by virtue of its low-cost manufacture, its ease of assembly with frame side members, and its self-drying capability. Note that this invention is not to be used with wooden screen frames, which are mitred at the corners.

### BRIEF SUMMARY OF THE INVENTION

It is an object of this invention to provide a screen printing frame connector that is low-cost to manufacture.

It is an object of this invention to provide a screen printing frame connector that is strong and durable in use.

It is an object of this invention to provide a screen printing frame connector that facilitates the drying of the frame by means of strategically placed holes.

It is a further object of this invention to provide a screen printing connector that is four-sided instead of two-sided.

Further objects of this invention can be discerned by perusing the detailed description, drawings, specifications and claims of this application.

### BRIEF DESCRIPTION OF THE DRAWINGS

The construction and operation of the invention can be readily appreciated from inspection of the drawings that accompany this application, combined with the detailed specification to follow.

FIG. 1 is a perspective drawing of the preferred embodiment of the invention.

FIG. 2 is an exploded diagram showing how the frame mates with the connector.

FIG. 3 is a top view of the invention.

FIG. 4 is cross-section view of the invention.

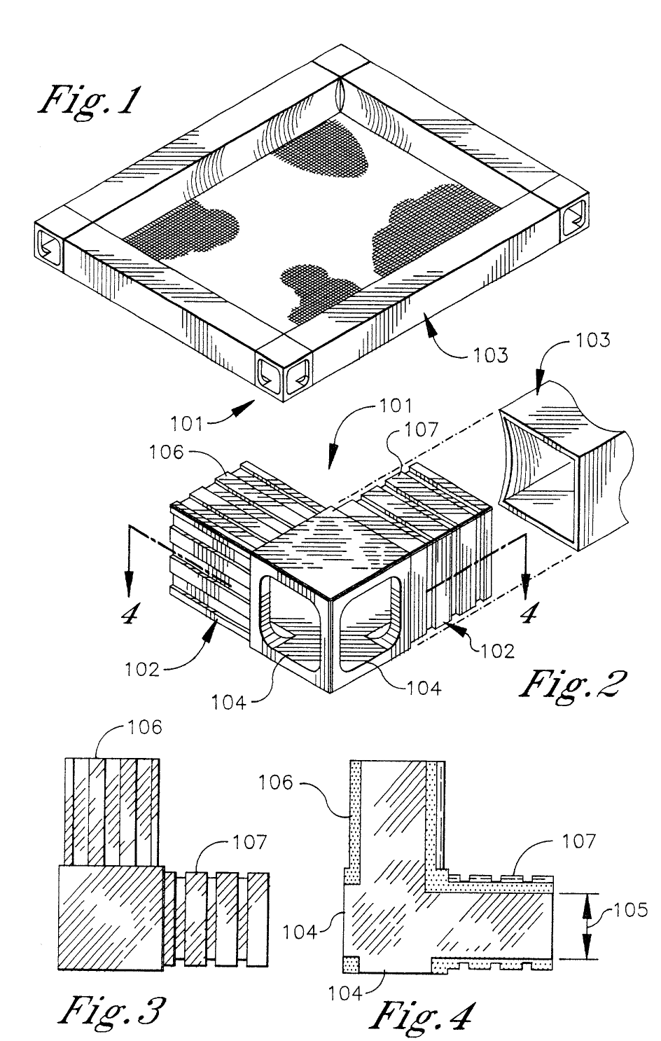

### DETAILED DESCRIPTION OF THE INVENTION

The invention is best described by referring to the preferred embodiment illustrated in the drawings in FIG. 2.

Referring to FIG. 2, a screen printing frame connector (connector) 101 is a structure that resembles a tube with a rectangular cross-section bent at a right angle, made out of rigid material. The connector has a mating flange on each end 102 that is sized to accept the end of a side member of a screen printing frame 103. The mating flange will have either a multiplicity of longitudinal ribs 106 or transverse ribs 107 as part of its structure. Since the invention is cast from plastic or soft metal, the ribs are molded into the body of the flange. The ribs are sheared away when the frame is mated to the flange, forming a water-tight seal.

The connector has two rectangularly-shaped holes in its sides, as shown in FIG. 2, to allow the drainage of water from the silk screen print frame 104. The interior of the connector is hollow, as shown in FIG. 3, and the cross-section 105 is sufficiently large to allow the free passage of water from the frame 104 and to facilitate air-drying.

While the foregoing describes a preferred embodiment, variation on this design and equivalent designs may be resorted to in the scope and spirit of the claimed invention.

What is claimed is:

1. A screen printing frame connector comprising
a frame connector body, the frame connector body hollow and cubical in shape, the frame connector body possessing two connector sides, the connector sides at right angles to each other, the frame connector also possessing two drain hole sides,
each connector side with a connector flange, each of the connector flanges extending out from the frame connector body as a cylinder with rectangular cross-section,
each drain hole side possessing a rectangular-shaped hole.

2. A screen printing frame connector as in claim 1, where the outside diameter of each connector flange is less than the width of the connector side.

3. A screen printing frame connector as in claim 1, where the drain hole sides are in the same plane with the connector sides.

4. A screen printing frame connector as in claim 1, where the frame connector body and connector flanges are cast in one piece of material.

5. A screen printing frame connector as in claim 1, where the frame connector body and connector flanges are made out of plastic.

6. A screen printing frame connector as in claim 1, where the frame connector body and connector flanges are made out of aluminum.
